(19) United States
(12) Patent Application Publication
(10) Pub. No.: US 2019/0381537 A1
(43) Pub. Date: Dec. 19, 2019

(54) Metering Apparatus for Compact Dedusting Apparatus

(71) Applicant: Pelletron Corporation, Lancaster, PA (US)

(72) Inventors: Joseph T. Lutz, Lancaster, PA (US); Amit K. Gautam, Lancaster, PA (US)

(73) Assignee: Pelletron Corporation, Lancaster, PA (US)

(21) Appl. No.: 16/010,032

(22) Filed: Jun. 15, 2018

(51) Int. Cl. B07B 11/04; B07B 4/02; B07B 11/06

(52) U.S. Cl. CPC B07B 11/04; B07B 11/06; B07B 4/02

(57) ABSTRACT

A compact dedusting apparatus induces air flow through the housing by a vacuum generator mounted within the housing. The discharge of dust and debris can be passed through a conduit to a remote location without losing air flow velocity to facilitate the use of the compact dedusting apparatus within a clean room. The metering apparatus is formed as a fixed shape device that closes against the floor of the infeed hopper to prevent the flow of particulate material into the dedusting apparatus. The fixed shape device is connected to a pneumatic cylinder mounted externally of the infeed hopper to provide selective vertical movement to the metering apparatus. Vertical movement of the metering apparatus is limited by slots formed in a mounting plate. The fixed shape member passes through the mounting plate for engagement with the pneumatic cylinder.

### FIELD OF THE INVENTION

The invention disclosed in this application is directed generally to the cleaning and handling of particulate materials, such as plastic pellets, regrind, tablets, grains, minerals, and the like, and particularly to a metering apparatus for a dedusting apparatus that is compactly configured to induce air flow therethrough to clean the particulate materials from dust and debris carried therewith and to provide the capability to discharge the collected dust and debris to a remote location to preserve the status of a clean room.

### BACKGROUND OF THE INVENTION

It is well known, particularly in the field of transporting and using particulate materials, commonly coarse powders, granules, pellets, and the like that it is important to keep product particles as free as possible of contaminants. Particulates are usually transported within a facility where they are to be mixed, packaged or used in a pressurized tubular system that in reality produces a stream of material that behaves somewhat like a fluid. As these materials move through the pipes, considerable friction is generated not only among the particles themselves, but also between the tube walls and the particles in the stream. In turn, this friction results in the development of particle dust, broken particles, fluff, and streamers (ribbon-like elements that can “grow” into quite long and tangled wads that will impede the flow of materials or even totally block the flow). The characteristics of such a transport system are quite well known, as is the importance and value of keeping product particles as free as possible of contaminants.

The term “contaminant” as used herein includes a broad range of foreign material, as well as the broken particles, dust, fluff and streamers mentioned in the preceding paragraph. In any case, contaminants are detrimental to the production of a high quality product, and in some situations a health risk to employees of the producer and possibly even a source of danger in that some contaminants can produce a dust cloud which, if exposed to an ignition source, may explode.

Considering product quality, and focusing on moldable plastics as a primary example, foreign material different in composition from the primary material, such as dust, non-uniform material of the primary product, fluff, and streamers, does not necessarily have the same melting temperatures as the primary product and causes flaws when the material is melted and molded. These flaws result in finished products that are not uniform in color, may contain bubbles, and often appear to be blemished or stained, and, therefore, cannot be sold. Heat in the injection molding machine can vaporize dust that leads to tiny gas bubbles in the finished product. Heat also burns dust and causes “black spots”, actually carbonized dust. Sometimes dust pockets in the machine don't melt and cause “soft spots” or “white spots” as these defects are commonly called. It is important to note that, since these same non-uniform materials often do not melt at the same temperature as the primary product, the un-melted contaminants cause friction and premature wear to the molding machines, resulting in downtime, lost production, reduced productivity, increased maintenance and, thus, increased overall production costs.

Conventional particulate material dedusting devices, such as is disclosed in U.S. Pat. No. 5,035,331, granted to Jerome I. Paulson on Jul. 30, 1991, utilize first and second wash decks, formed as sloped planar surfaces within the apparatus and having openings therein for the passage of pressurized air therethrough to pass through particulate material flowing along the wash decks. Between the two wash decks, the particulate material passes through a Venturi zone, which combined with the passage of air through the particulate material on the wash decks, discharges dust and other contaminates upwardly with the air flow to be discharged from the apparatus.

In U.S. Pat. No. 7,380,670, granted on Jun. 3, 2008, to Jerome I. Paulson, Heinz Schneider and Paul Wagner, a compact dedusting apparatus having back-to-back wash deck assemblies, provides increased capacity by doubling the wash decks and the Venturi zones, which requires the inflow of particulate material to be equally divided between the two wash deck assemblies. In both U.S. Pat. Nos. 5,035,331 and 7,380,670, a magnetic flux field is applied to the infeed of particulate material to neutralize the static charges attracting the contaminates to the particulate pellets to enhance the operation of the wash decks in separating contaminates from the particulate material.

Uniceltec, a Korean Corporation, developed and marketed a compact dedusting apparatus disclosed in PCT Patent Application No. PCT/KR2013/002924, filed on Apr. 8, 2013, by Joong Soon Kim, et al. This compact dedusting apparatus, with appropriate improvements to meet the demands of the U. S. market, has been marketed in the U. S. by Pelletron Corporation as the Model C-20 dedusting apparatus. Applicants have made significant additional improvements to the Model C-20 dedusting apparatus and desire to protect such improvements by way of this patent application.

Among the problems found in the presently marketed C-20 dedusting apparatus as developed by Uniceltec is the provision of a urethane metering device that wears through engagement with the particulate materials and adds a corresponding amount of dust into the flow of particulate material to be cleaned. The Model C-20 dedusting apparatus has the capability of being utilized in a clean room, i.e. a room in which ambient dust is not permitted due to the particular operation being conducted within the clean room. The previous model of this compact dedusting apparatus developed in Korea by Uniceltec utilized a compressed air powered vacuum generator to provide cleaning of the particulate material, which requires discharge from the dedusting apparatus, even if passed through a dust collection apparatus. This arrangement does not permit the remote discharge of the collected dust and debris and the air flow. Lastly, the dedusting apparatus developed by Uniceltec had a problem with carryover of particulate material with the discharged dust and debris, resulting in a loss of particulate material.

In U.S. Pat. No. 9,962,741, granted on May 8, 2018, to Heinz Schneider and Joseph T. Lutz, the compact dedusting apparatus with remote discharge to which the instant application is an improvement is shown and described. In this Schneider patent, the particulate material infeed hopper is provided with a rotatable, fluted metering device, which requires a powered motor, preferably in the form of an electric motor, to provide rotative power to the fluted metering device. It would be desirable to provide a metering device which is simpler in configuration and more effective in operation to both meter the flow of particulate material through the dedusting apparatus, but also to provide a mechanism that would provide a positive stop against the infeed hopper when the flow of particulate material is to cease.

Accordingly, it would be desirable to provide a compact dedusting apparatus that would solve the problems of the previously developed dedusting apparatus, particularly with respect to the metering apparatus.

### SUMMARY OF THE INVENTION

It is an object of this invention to provide a compact dedusting apparatus for use in clean rooms to clean particulate material, such as plastic pellets, to remove dust and debris therefrom.

It is another object of this invention to provide a compact dedusting apparatus that solves the known problems of the previously developed compact dedusting apparatus.

It is a feature of this invention that air flow is induced through the compact dedusting apparatus by a vacuum.

It is another feature of this invention that the vacuum generator inducing a flow of air through the compact dedusting apparatus by a vacuum is located in the housing for the compact dedusting apparatus and is large enough to permit remote positioning of the dust collection apparatus.

It is an advantage of this invention that the positioning of the vacuum generator in the housing of the dedusting apparatus that the dust collection apparatus can be remotely located relative to the dedusting apparatus without diminishing air flow through the dedusting apparatus.

It is still another feature of this invention that the shape of the discharge transition between the Venturi chamber within the dedusting apparatus and the dirty air discharge port has been enlarged to provide a larger cross-section area.

It is another advantage of this invention that the enlarged cross-sectional area of the discharge transition operates to slow the speed of the air flow within the discharge transition.

It is still another advantage of this invention that the slowed air flow speed within the enlarged discharge transition allows the heavier carryover plastic pellets being carried with the dust and debris toward the dirty air discharge opening to drop out of the air flow toward the cleaned product material discharge opening while the collected dust and debris continue toward the dirty air discharge opening.

It is yet another feature of this invention that the metering device can be formed from stainless steel.

It is yet another advantage of this invention that the stainless steel metering device does not wear from engagement with plastic particulates and does not add an addition measure of dust to the flow of particulate material to be cleaned therefrom.

It is still another feature of this invention that the metering apparatus is mounted to an external mounting plate that is cooperative with a linear actuator to raise and lower the metering apparatus.

It is a further feature of this invention that the vertical movement of the metering apparatus is limited by slots formed in the mounting plate.

It is a further advantage of this invention that the metering apparatus can be selectively operated by a pneumatic cylinder, electric motor, hydraulic cylinder or a combination of electric motor and pneumatic cylinder that would convert rotary motion into linear motion, supported on the housing of the dedusting apparatus and operatively connected to the metering apparatus.

It is still a further advantage of this invention that the pneumatic cylinder can be operatively controlled by a control mechanism that causes selective vertical movement of the pneumatic cylinder to control the flow rate of particulate material through the dedusting apparatus.

It is yet a further feature of this invention that ionization pins can be mounted in the compact dedusting mechanism within the flow of particulate material passing through the metering device to induce negative ions onto the plastic pellets to separate microscopic dust particles from the plastic pellets to facilitate cleaning thereof within the Venturi chamber.

It is still another feature of this invention that compressed air is forced around the ionization pins to push ions into the flow of particulate material flowing past the ionization pins.

It is still another advantage of this invention that the use of compressed air to move ions into the flow of particulate material results in a higher population of individual pellets having negative ions attached to repel dust particles and facilitate cleaning of the particulate material.

It is yet another feature of this invention that the collected dust and debris cleaned from the particulate material is discharged from the compact dedusting apparatus through a conduit under negative pressure.

It is yet another advantage of this invention that the utilization of a discharge conduit under negative pressure allows a leak to occur in the discharge conduit without spilling the contents of the discharge conduit into the atmosphere.

It is a further advantage of this invention that the use of a discharge conduit under negative pressure makes this dedusting apparatus capable of use in a clean room.

It is a further advantage of this invention that a compact dedusting apparatus is not limited to cleaning pellets that are within the temperature limits of a plastic feed device.

It is a further object of this invention to provide a compact dedusting apparatus that has the capability of remote discharge for the collected dust and debris which is durable in construction, inexpensive of manufacture, carefree of maintenance, easy to assemble, and simple and effective in use.

These and other objects, features and advantages are accomplished according to the instant invention by providing a compact dedusting apparatus in which the air flow is induced through the housing by a vacuum generator mounted within the housing. The discharge of dust and debris can be passed through a conduit to a remote location without losing air flow velocity to facilitate the use of the compact dedusting apparatus within a clean room. The metering apparatus is formed as a fixed shape device that closes against the floor of the infeed hopper to prevent the flow of particulate material into the dedusting apparatus. The fixed shape device is connected to a pneumatic cylinder mounted externally of the infeed hopper to provide selective vertical movement to the metering apparatus. Vertical movement is limited by slots formed in a mounting plate. The discharge transition is formed with an enlarged cross-sectional area compared to the shape of the Venturi zone so that carryover pellets can be returned to the product flow instead of being lost with the dirty air discharge.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a perspective view of a compact dedusting apparatus incorporating the principles of the instant invention;

FIG. 2 is side elevational view of the compact dedusting apparatus shown in FIG. 1;

FIG. 3 is a front elevational view of the compact dedusting apparatus remote from the dust collection apparatus;

FIG. 4 is a top plan view of the compact dedusting apparatus;

FIG. 5 is a cross-sectional view of the compact dedusting apparatus corresponding to lines A-A in FIG. 2;

FIG. 6 is a cross-sectional view of the compact dedusting apparatus corresponding to lines B-B of FIG. 3;

FIG. 7 is an enlarged front elevational view of the mounting plate on which the metering device is supported for vertical movement thereof, corresponding to circle C in FIG. 2; and

FIG. 8 is a cross-sectional view of the dedusting apparatus corresponding to a vertical plane passing transversely through the infeed hopper to show the metering apparatus in the infeed hopper.

### DETAILED DESCRIPTION OF THE PREFERRED EMBODIMENT

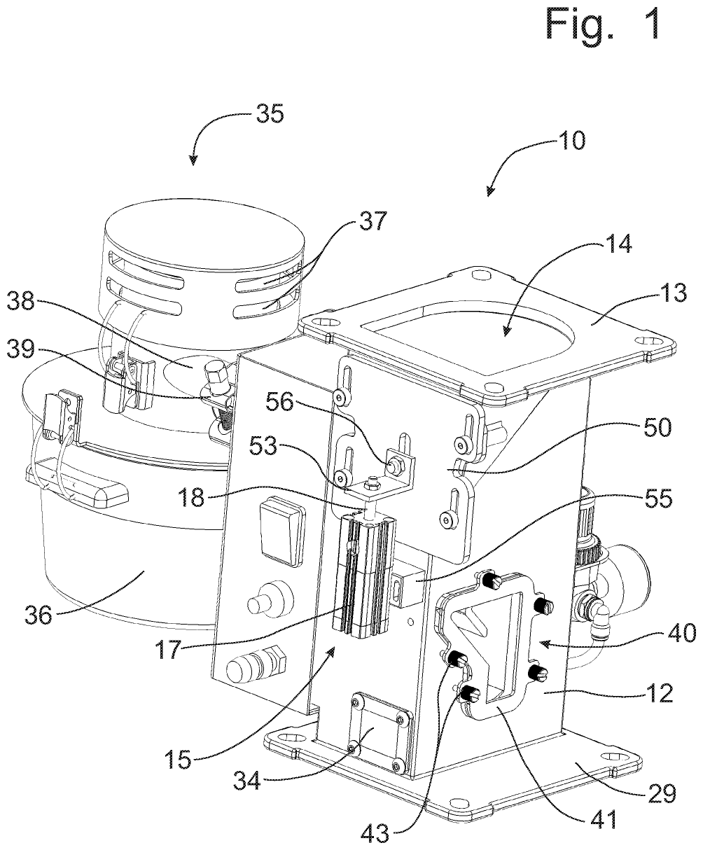

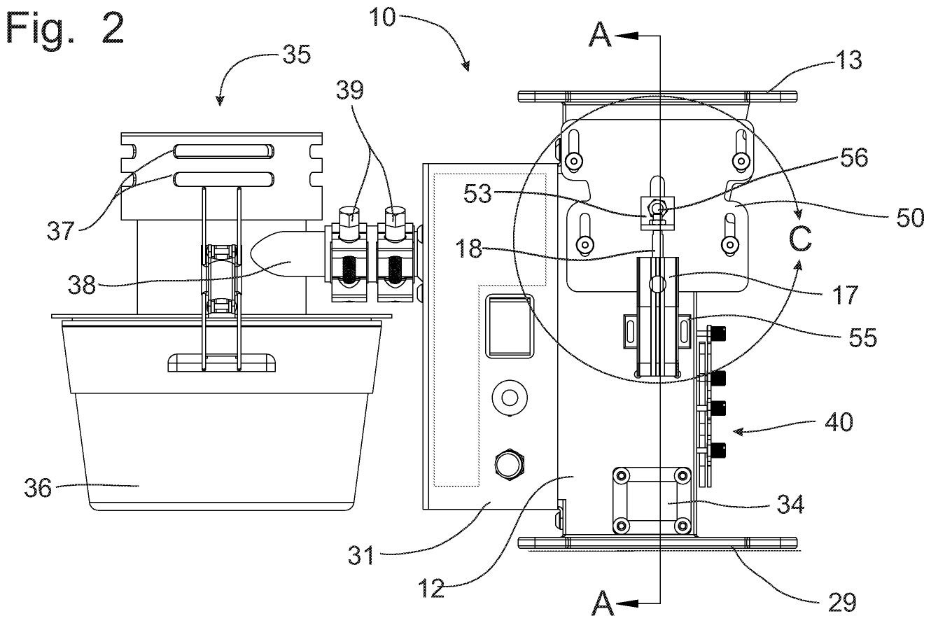

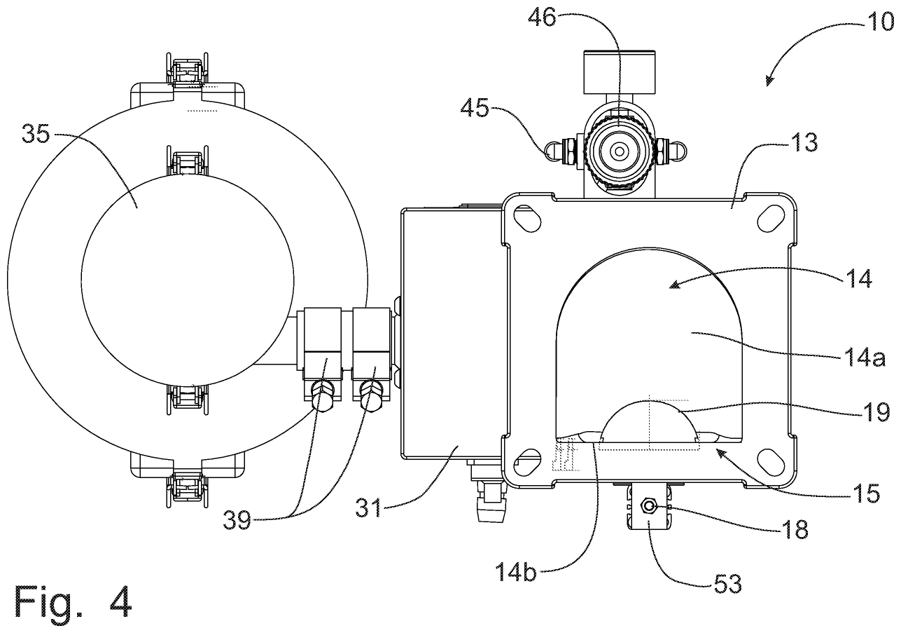

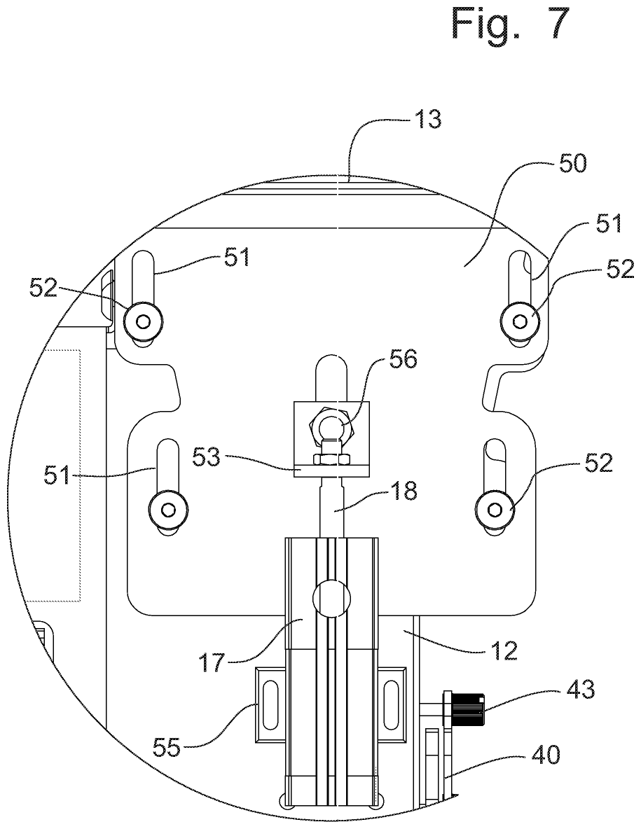

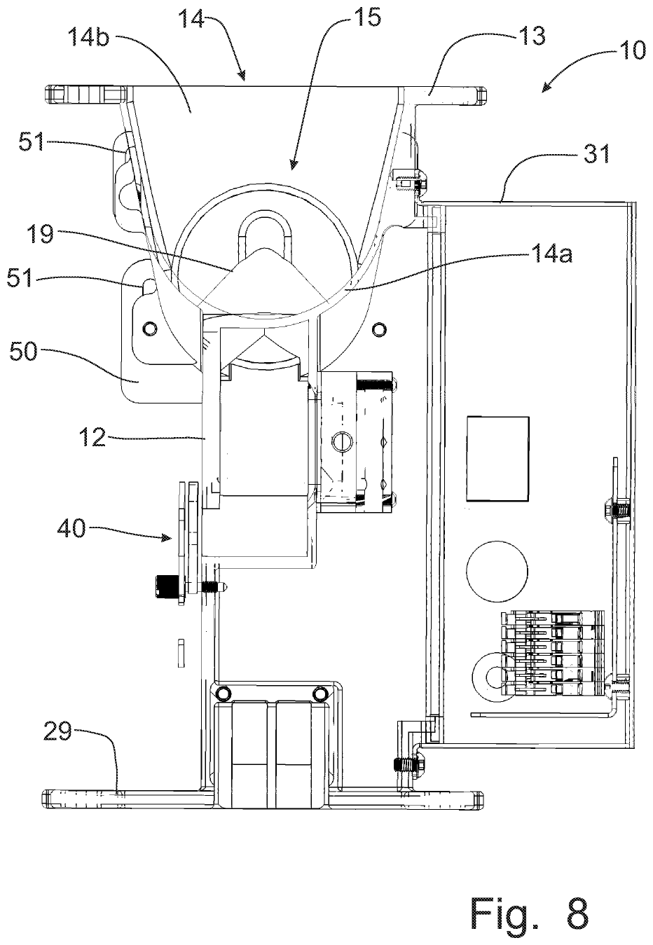

Referring to FIGS. 1-8, a compact dedusting apparatus incorporating the principles of the instant invention can best be seen. The compact dedusting apparatus utilizes the general dedusting techniques disclosed in U.S. Pat. No. 5,035,331, issued to Jerome I. Paulson on Jun. 3, 1991, including the passage of air through a Venturi zone where particulate material passes and air removes the dust and debris from the particulate material and the particulate material is subjected to an electro-magnetic ionization to induce negative ions on the particulate material to separate the pellets from the minute dust particles. However, these known contaminate removing techniques are structured in a different configuration that is generally depicted in PCT Patent Application No. PCT/KR2013/002924, filed on Apr. 8, 2013, by Joong Soon Kim, et al. Applicants, however, have improved on the Kim dedusting apparatus as will be described in greater detail below.

The dedusting apparatus 10 is generally rectangular in shape and configuration. The outer housing 12 is preferably formed of a durable material such as steel or cast iron, and can be formed by casting techniques. The top of the housing 12 is formed with an attachment flange 13 that can be connected to a supply of particulate material for introduction into the infeed opening 14 at the top of the housing 12. The infeed hopper 14 is formed with a downwardly sloped, curved floor 14a that directs the flow of particulate material toward a metering apparatus 15 that overlies the infeed port 16 formed in the floor 14a. The metering apparatus 15 is formed of a fixed shape flow control member 19 that conforms to the shape of the floor 14a of the infeed hopper 14 so as to be capable of stopping the flow of particulate material past the flow control member 19 and into and through the infeed opening 16.

The flow control member 19 is vertically movable against the planar back wall 14b of the infeed hopper 14 to control a gap between the flow control member 19 and the floor 14a of the infeed hopper 14, which in turn controls the flow rate of particulate material into the infeed opening 16. To affect the vertical movement of the flow control member 19, the flow control member 19 includes a rearwardly projecting actuator hub 56 that passes through an opening in the planar back wall 14b of the infeed hopper 14 and through a mounting plate 50 secured to the housing 12 of the dedusting apparatus 10. The actuator hub 56 is secured to a connection bracket 53 so that the connection bracket 53 is vertically movable with the actuator hub 56. The connection bracket 53 is coupled to the rod 18 of the vertically oriented pneumatic cylinder 17 supported on a support bracket 55 attached to the housing 12. One of ordinary skill in the art will recognize that the connection bracket 53 could also be coupled to a mechanism that converts rotary motion from a standard electric motor to a vertical translation motion.

The mounting plate 50 is affixed to the housing 12 and is formed with a plurality of vertical slots 51 to accommodate the vertical movement of the flow control member 19. One slot 51 through the mounting plate 50 corresponds to the actuator hub 56 and provides a limit to the vertical movement permitted to the flow control member 19. Another four slots 15 are spaced around the mounting plate 50 and are associated with fasteners 52 that connect to the flow control member 19 and move along the slots 51 to provide uniform vertical movement for the flow control member 19. The linear actuator 17 is preferably a pneumatic cylinder, but could also be in the form of a hydraulic cylinder or an electric linear screw that moves the rod 18 vertically, or other device that converts the rotary motion of a standard electric motor into a vertical translation movement. Accordingly, the linear actuator 17 will be powered through the electrical housing 31.

In operation, the metering apparatus 15 can be controlled through a microprocessor that controls the operation of the pneumatic cylinder 17 in response to a programmed flow rate through the dedusting apparatus 10. Alternatively, the pneumatic cylinder 17 can be controlled manually and remotely as selectively desired for optimal operation of the dedusting apparatus 10. When a greater flow rate of particulate material is desired, the pneumatic cylinder 17 is extended, which moves the actuator hub 56 upwardly and, in turn, moved the flow control member 19 vertically to increase the gap between the flow control member 19 and the sloped floor 14a of the infeed hopper 14. Reducing the flow rate requires the contraction of the pneumatic cylinder 17 to move the flow control member 19 closer to the floor 14a. To provide a positive stopping of the flow of particulate material, the pneumatic cylinder 17 is collapsed completely, pulling the flow control member 19 into engagement with the floor 14a. Since the shape of the peripheral edge of the flow control member 19 is mated to the floor 14a, the particulate material cannot pass the flow control member 19 and flow stops.

Preferably the flow control member 19 is formed of stainless steel so that the engagement thereof by the particulate material passing by the flow control member 19 will not wear the flow control member 19 and create additional dust passing through with the particulate material to be cleaned therefrom, as is the case with conventional conical, fluted members 19 formed from plastic.

The metered particulate material passes through the infeed port 16 into a first chamber 21 of the dedusting area 20. A series of ionizing pins 25 induce negative ions onto the individual pellets as the particulate material passes downwardly through a vertical portion 22 of the first chamber 21. The particulate material then encounters a downwardly sloped floor 23 that creates a sloped portion 24 of the first chamber 21 to direct the ionized particulate material into the vertical Venturi chamber 26 which oriented parallel to, but offset from the vertical portion 22 by the sloped portion 24. A flow of cleaning air is fed upwardly, as will be described in greater detail below, through the Venturi chamber 26 so that the air will lift the dust particles and the debris, which are both significantly lighter that the individual pellets of the particulate material, thereby removing the dust and debris and cleaning the particulate material. The dust and debris laden air is then discharged from the dedusting area 20, as will be described in greater detail below. The cleaned particulate material then passes downwardly by gravity through the product discharge opening 28 at the bottom of the housing 12.

The air flow through the Venturi chamber 26 is preferably generated by a vacuum generator 30 in the form of a line vac mounted in an electrical enclosure 31 supported from the housing 12 to create an air flow through a conduit 33 passing from the dedusting area 20 to the dust collector 35 offset from the dedusting apparatus 10. One skilled in the art will recognize that the location of the vacuum generator 30 could also be placed in the housing 12 depending on the configuration of the housing 12. The conduit 33 is in open communication with the Venturi chamber 26 at a discharge transition chamber 26a forming an upper portion of the Venturi chamber 26 to draw the dust and debris laden air from the Venturi chamber 26 into the conduit 33. This vacuum draws air into the Venturi chamber 26 from the product discharge opening 28 at the bottom of the housing 12.

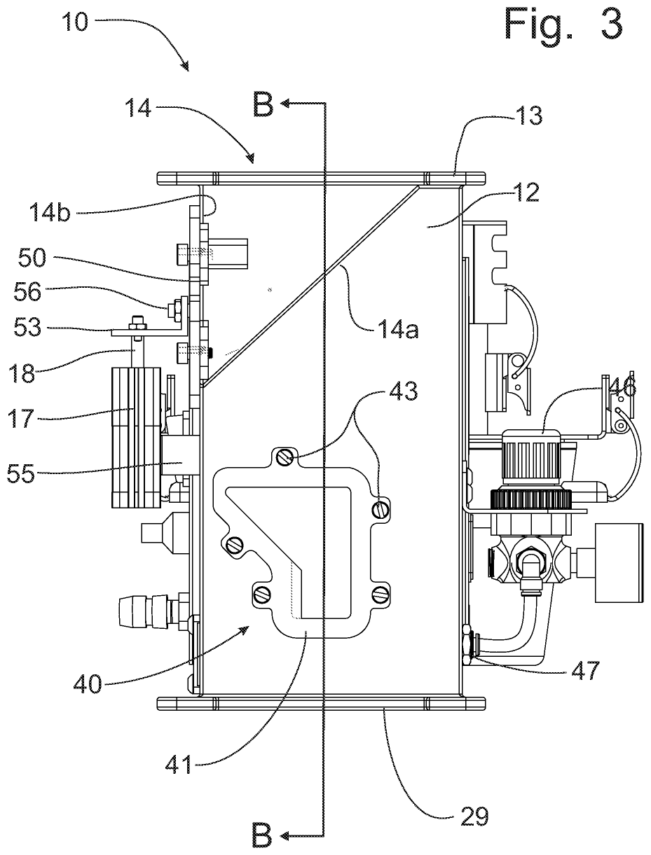

The vacuum generator 30 receives compressed air for the operation thereof from a supply of compressed air connected to the compressed air connector 45 on the back side of the housing 12, as best seen in FIGS. 3-5. The compressed air flows through a pressure regulator 46 and is fed into a Wye connector port 47 in the housing 12. The Wye connector port 47 divides the flow of compressed air into two paths (not shown). One flow path delivers compressed air to the ionizer pins 25 where the compressed air flows around the ionizer pins 25 to force ions into the flow of particulate material passing through the vertical portion 22 of the first chamber 21. The second flow path delivers compressed air to the vacuum generator 30 which converts the relatively high pressure, low volume air flow into a relatively low pressure, high volume air flow through the vacuum generator 30 to draw air through the discharge conduit 33 by the generation of a vacuum.

Under certain circumstances relating to the use of the compact dedusting apparatus 10, the mounting flange 29 at the bottom of the housing 12 can be connected to a receiving device (not shown) that receives the cleaned product. The receiving device can seal against the mounting flange 29 which would prevent the vacuum generator 30 from drawing air through the product discharge opening 28. Utilization of the compact dedusting apparatus 10 in a clean room is a circumstance in which a receiving device is sealed against the lower mounting flange 29. In such circumstances, a filtered auxiliary port 34 is opened to allow air to be drawn through a clean air inlet port 27 positioned adjacent the product discharge opening 28 so that the air will enter the Venturi chamber 26 through the product discharge opening 28.

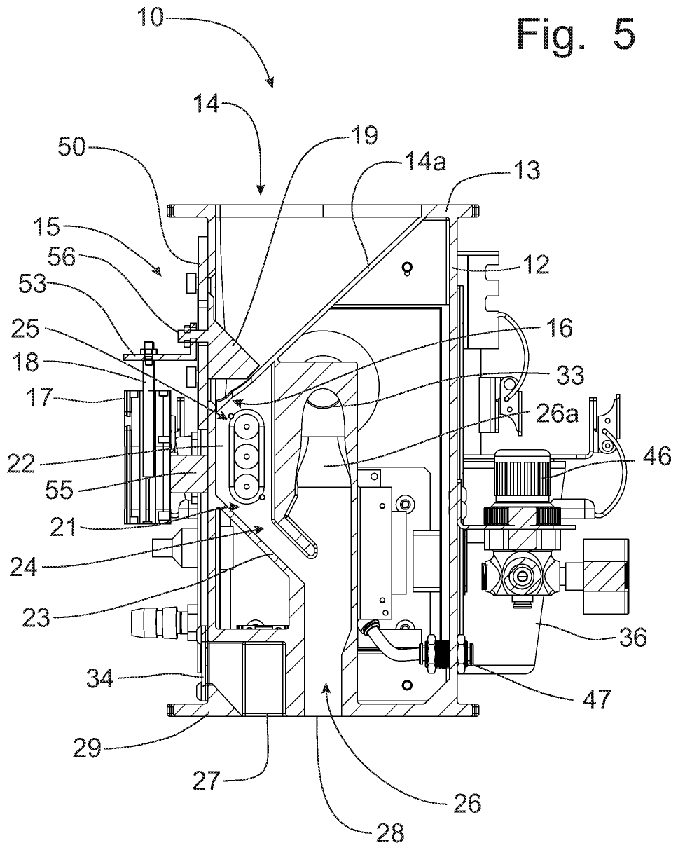

The upward movement of cleaning air through the Venturi chamber 26 is moving at a selected velocity, which can vary depending on the particulate material being cleaned, to carry the dust and debris upwardly while allowing the pellets to fall downwardly. Sometimes, however, pellets get entrained in the upward air flow, which is commonly referred to as carryover. Once the entrained air flow reaches the conduit 33, which has a smaller cross-sectional area than the Venturi chamber 26, the velocity of the air flow increases, which further entrains carryover pellets. To allow carryover pellets to drop back downwardly toward the product discharge opening 28, the discharge transition chamber 26a of the Venturi chamber 26 is widened, as is best seen in FIG. 5, to have a larger cross-sectional area than the Venturi chamber 26 below the sloped floor 23, which causes the velocity of the air flow to decrease and provides an opportunity for the carryover pellets to fall out of entrainment and drop toward the product discharge opening 28 before being drawn into the conduit 33.

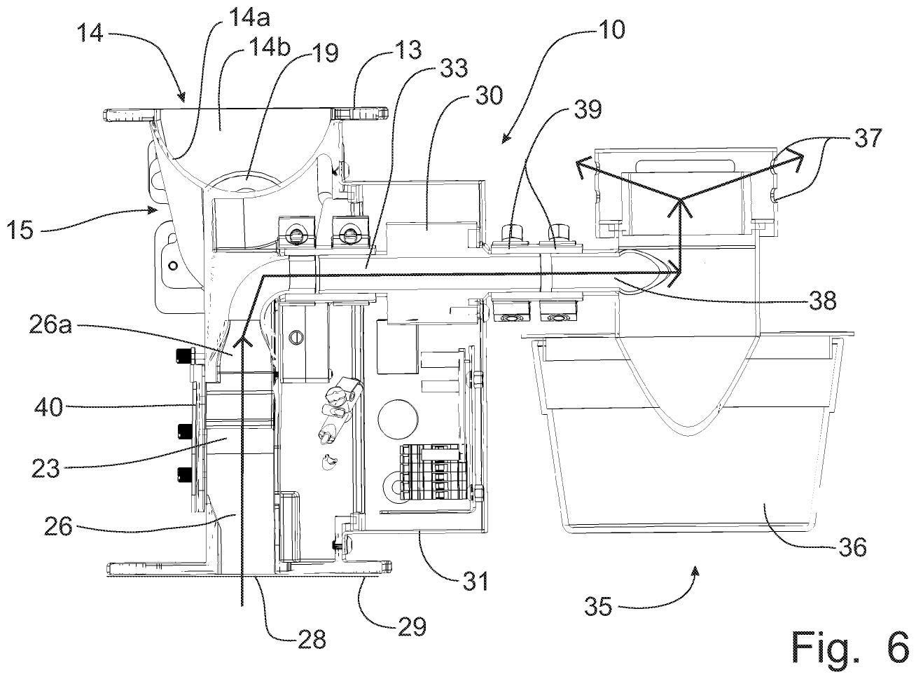

As is best seen in FIG. 6, the conduit 33 extends beyond the vacuum generator 30 toward the dust collector 35. Although the dust collector 35 can be formed in different configurations, including filters, scrubbers and cyclones, among others, a compact dust collector 35 that spins the dust and debris laden air to separate the dust particles and debris therefrom is effective. The separated dust and debris is collected in a removable container 36 at the bottom of the dust collector 35, while the cleaned air is discharged through vents 37 at the top of the dust collector 35. In certain circumstances, such as clean rooms, discharging the cleaned air into atmosphere is not acceptable. In such circumstance, the dust collector 35 can be located at a remote location where the discharge of the cleaned air is acceptable, and the conduit 33 extended to the remote location.

When the vacuum generator 30 is located with the dust collector 35, as is known in the Kim dedusting apparatus depicted in PCT Patent Application No. PCT/KR2013/002924, the velocity of the air flow through the Venturi chamber 26 is adversely affected by placing the dust collector 35 and vacuum generator 30 at a remote location. Accordingly, the placement of the vacuum generator 30 within the electrical enclosure 31 enables the dust collector 35 to be remotely located without adversely changing the air flow through the dedusting apparatus 10. For this reason, the conduit 33 terminates at an appropriate distance outside of the electrical enclosure 31 so that the inlet conduit 38 of the dust collector 35 can be connected to the conduit 33 and secured by clamps 39. In circumstances where the dust collector 35 is to be remotely located, the clamps 39 are disconnected to allow the dust collector 35 to be appropriately positioned while a length of conduit extension (not shown) is interconnected between the conduit 33 and the inlet conduit 38 to carry the dust and debris laden air to the remotely located dust collector 35.

An additional improvement to the Kim compact dedusting apparatus as depicted in PCT Patent Application No. PCT/KR2013/002924 is the provision of a Plexiglas window 40 in the side of the housing corresponding to the location of the Venturi chamber 26. The Plexiglas window 40 is shaped to correspond to the shape of the sloped portion 24 of the first chamber and the lower vertical portion of the Venturi chamber 26 to permit the operator to observe the operation of the dedusting apparatus 10 so that appropriate adjustments can be made to the flow rate of the particulate material fed into the first chamber 21 or the rate of velocity of the air flow through the Venturi chamber 26 to provide an effective cleansing of the particulate material. The Plexiglas window 40 is mounted in a frame 41 and secured to and sealed against the housing 12 by fasteners 43. One skilled in the art will understand that a sensor (not shown) could be mounted on the window to detect particulate material collecting in the dedusting area 20, which can occur when the process consuming the cleaned particulate material passing through the product discharge opening 28 stops working.

In operation, the compact dedusting apparatus 10 is positioned to receive a supply of particulate material into the infeed opening 14 at the top of the housing 12. Such positioning could require that the upper mounting flange 13 being connected to the apparatus providing a supply of the particulate material. The metering apparatus 15 is positioned to control the flow of particulate material through the infeed port 16 in a desired manner and flow rate, and then into the dedusting area 20. The particulate pellets are subjected to ionization by the ionization pins 25 located in the vertical portion 22 of the first chamber 21. The ionized pellets then land on the sloped floor 23 to guide the pellets into the Venturi chamber 26 where a flow of air coming upwardly through the product discharge opening 28 removes the dust particles and debris from the pellets so that the cleaned pellets can continue to fall by gravity downwardly and pass through the product discharge opening 28.

The dust and debris laden air continues to flow upwardly to a discharge conduit 33 located at the top of a discharge transition chamber 26a of the Venturi chamber 26. Between the lower vertical portion of the Venturi chamber 26 and the discharge conduit 33, the discharge transition chamber 26a of the Venturi chamber 26 expands in size and cross-sectional area so that the velocity of the air flow is reduced to allow an carryover pellets to drop out of entrainment in the air flow before moving into the discharge conduit 33. The dust and debris laden air continues through the vacuum generator 30 to the dust collector 35, which can be located at a remote location and connected to said conduit 33 by a supplemental conduit (not shown). Since the vacuum generator 30 is located in the electrical enclosure 31, the dust collector 35 can be positioned remotely from the dedusting apparatus 10 without deteriorating the flow of air through the Venturi chamber 26.

The upper mounting flange 13 is configured so that the upper mounting flange 13 does not overlie the infeed opening 14 and provide structure for particulate material to collect and detract from the operating efficiency of the dedusting apparatus 10. The housing 12 has an opening therein covered by a transparent window 40, which could be glass, polycarbonate, acrylic or other clear material, mounted in a frame 41 and secured to the housing 12 by fasteners 43 so that the operator can observe the operation of the dedusting area 20 and make operational adjustments as needed. When the lower mounting flange 29 is sealed against a receiving device (not shown) the flow of cleaning air can pass through a clean air inlet port 27 that extends from the side of the housing 12 to an opening in said lower mounting flange adjacent the product discharge opening 28 so that air can be drawn through the clean air inlet port 27 and then upwardly through the product discharge opening 28 to fill the Venturi chamber 26 and remove dust and debris from the particulate material.

It will be understood that changes in the details, materials, steps and arrangements of parts, which have been described and illustrated to explain the nature of the invention will occur to and may be made by those skilled in the art upon a reading of this disclosure within the principles of the scope of the invention. The foregoing description illustrates the preferred embodiment of the invention; however, concepts, as based upon the description may be employed in other embodiments without departing from the scope of the invention. Accordingly, the following claims are intended to protect the invention broadly, as well as in the specific form shown.

Having thus described the invention, what is claimed is:

1. A dedusting apparatus for cleaning contaminates from particulate material, comprising:
a housing defining a dedusting area for removing contaminates from particulate material;
an infeed hopper located at an upper portion of said housing to receive a supply of particulate material, said infeed hopper including a planar vertical back wall and a sloped floor to direct particulate material downwardly toward an infeed port at a bottom portion of said infeed hopper;
a metering apparatus located within said infeed opening and being operable to control the flow of particulate material through said infeed port, said metering device including a flow control member being vertically movable between a lowermost position and an uppermost position, said flow control member having a peripheral edge that mates against said sloped floor of said infeed hopper so that said flow control member can stop the flow of particulate material through said infeed port when said flow control member is positioned at said lowermost position;
a Venturi chamber positioned to receive particulate material passing through said infeed port and to remove dust and debris from the particulate material by a flow of air passing upwardly through the product discharge opening into the Venturi chamber, while cleaned particulate material falls through the product discharge opening; and
a discharge conduit positioned above the Venturi chamber to receive dust and debris laden air moving upwardly from said venture chamber, said discharge conduit moving said dust and debris laden air remotely from said dedusting area.

2. The dedusting apparatus of claim 1 wherein said flow control member is selectively positionable between said lowermost position and said uppermost position by an actuator supported on said housing externally of said infeed hopper.

3. The dedusting apparatus of claim 2 wherein said flow control member includes an actuator hub that extends rearwardly through an opening in said back wall of said infeed hopper and through a slot in a mounting plate affixed to said housing externally of said infeed hopper.

4. The dedusting apparatus of claim 3 wherein said actuator hub is operatively connected to a vertically movable rod of a linear actuator such that the flow control member moves in conjunction with extension and contraction of said vertically movable rod relative to said linear actuator, said linear actuator being mounted to said housing externally of said infeed hopper.

5. The dedusting apparatus of claim 4 wherein a connection bracket is secured to said actuator hub and to said movable rod to permit the transfer of vertical movement from said movable rod to said actuator hub.

6. The dedusting apparatus of claim 4 wherein said mounting plate is formed with a plurality of vertically oriented slots accommodating a movement of fasteners passing through said slots, said fasteners being connected to said flow control member to provide a uniform vertical movement of said flow control member.

7. A metering apparatus for a dedusting apparatus operable to clean contaminates from particulate material, said dedusting apparatus including an infeed hopper having a planar vertical back wall and a sloped floor to direct particulate material downwardly toward an infeed port at a bottom portion of said infeed hopper, said metering device comprising:
a flow control member being vertically movable between a lowermost position and an uppermost position so as to be operable to control the rate of flow of particulate material through said infeed port, said flow control member having a peripheral edge that mates against said sloped floor of said infeed hopper so that said flow control member can stop the flow of particulate material through said infeed port when said flow control member is positioned at said lowermost position.

8. The metering apparatus of claim 7 wherein said flow control member is selectively positionable between said lowermost position and said uppermost position by an actuator supported externally of said infeed hopper.

9. The metering apparatus of claim 8 wherein said flow control member includes an actuator hub that extends rearwardly through an opening in said back wall of said infeed hopper and through a slot in a mounting plate affixed to said housing externally of said infeed hopper.

10. The metering apparatus of claim 9 wherein said actuator hub is operatively connected to a vertically movable rod of a linear actuator such that the flow control member moves in conjunction with extension and contraction of said vertically movable rod relative to said linear actuator, said linear actuator being mounted externally of said infeed hopper.

11. The metering apparatus of claim 10 wherein said linear actuator is a pneumatic cylinder.

12. The dedusting apparatus of claim 10 wherein said mounting plate is formed with a plurality of vertically oriented slots accommodating a movement of fasteners passing through said slots, said fasteners being connected to said flow control member to provide a uniform vertical movement of said flow control member.

13. In a dedusting apparatus having an infeed hopper including a planar vertical back wall and a sloped floor to direct particulate material downwardly toward an infeed port at a bottom portion of said infeed hopper, the improvement comprising:
a metering apparatus positioned within said infeed hopper and including a flow control member being vertically movable between a lowermost position and an uppermost position so as to be operable to control the rate of flow of particulate material through said infeed port, said flow control member having a peripheral edge that mates against said sloped floor of said infeed hopper so that said flow control member can stop the flow of particulate material through said infeed port when said flow control member is positioned at said lowermost position.

14. The dedusting apparatus of claim 13 wherein said flow control member is selectively positionable between said lowermost position and said uppermost position by an actuator supported on said housing externally of said infeed hopper.

15. The dedusting apparatus of claim 14 wherein said flow control member includes an actuator hub that extends rearwardly through an opening in said back wall of said infeed hopper and through a slot in a mounting plate affixed to said housing externally of said infeed hopper.

16. The dedusting apparatus of claim 15 wherein linear actuator is a pneumatic cylinder having a vertically movable rod.

17. The dedusting apparatus of claim 16 wherein said actuator hub is operatively connected to said vertically movable rod of said pneumatic cylinder such that the flow control member moves in conjunction with extension and contraction of said vertically movable rod relative to said pneumatic cylinder, said pneumatic cylinder being mounted externally of said infeed hopper.

18. The dedusting apparatus of claim 17 wherein a connection bracket is secured to said actuator hub and to said movable rod to permit the transfer of vertical movement from said movable rod to said actuator hub.

19. The dedusting apparatus of claim 17 wherein said mounting plate is formed with a plurality of vertically oriented slots accommodating a movement of fasteners passing through said slots, said fasteners being connected to said flow control member to provide a uniform vertical movement of said flow control member.
